(19) United States
(12) Patent Application Publication
(10) Pub. No.: US 2009/0314679 A1
(43) Pub. Date: Dec. 24, 2009

(54) Prevention of Food Spoilage

(76) Inventor: David Wagner, Santa Rosa, CA (US)

Correspondence Address: EDWARD S. SHERMAN, ESQ., 3554 ROUND BARN BLVD., SUITE 303, SANTA ROSA, CA, 95403, US

(21) Appl. No.: 12/141,548

(22) Filed: Jun. 18, 2008

(51) Int. Cl. B65D 85/34; A23L 3/00

(52) U.S. Cl. 206/524.6; 426/321

(57) ABSTRACT

The shelf life of food and produce is extended by exposure to Tachyonized materials. Tachyonized materials, such as silica, may be incorporated in container for food storage and display.

### CROSS REFERENCE TO RELATED APPLICATIONS

None

### BACKGROUND OF INVENTION

The present invention relates to improvements in food storage to prevent spoilage, in particular means for storing produce under non-refrigerated conditions that retard spoilage

Food spoilage is costly for both produces and consumers. In a world where many people go hungry improved means to store food and prevent rot and wastage will increase the available food resource to feed the hungry. While the shelf life of produce can be prolonged under refrigerated conditions, this is costly, and may not be available during transport or when electrical service is not available or reliable.

It is therefore a first object of the present invention to provide an improved means to preserve produce without refrigeration.

### SUMMARY OF INVENTION

In the present invention, the first object is achieved by providing a process for extending the shelf life of perishable produce, the process comprising the steps of providing a Tachyonized material, providing produce to be preserved, and then placing the produce in close proximity to the Tachyonized material.

A second aspect of the invention is characterized by a container or device for storing produce, the device comprising a container having a bottom portion and upward extending sides connected to the periphery of the bottom portion which terminate at the opposite end at a rim to provide a cavity for retaining material, with a Tachyonized material disposed at the bottom of said container.

The above and other objects, effects, features, and advantages of the present invention will become more apparent from the following description of the embodiments thereof taken in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.”

FIG. 1 is a color photograph comparing the treated (“T”) tomatoes on the left with the untreated or control tomato on the right, at the beginning of the experiment.

FIG. 2 is a color photograph comparing the treated (“T”) tomatoes on the left with the untreated or control tomato on the right, 13 days into the experiment.

FIG. 3 is a color photograph comparing the treated (“T”) tomatoes on the left with the untreated or control tomato on the right, 26 days into the experiment.

FIG. 4 is a color photograph comparing the treated (“T”) tomatoes on the left with the untreated or control tomato on the right, 39 days into the experiment.

FIG. 5 is a color photograph comparing the treated (“T”) tomatoes on the left with the untreated or control tomato on the right, 52 days into the experiment and untreated o (cross-section view, plan view, elevation, diagram, schematic illustration, plot) . . . showing

FIG. 6 is a color photograph comparing the treated (“T”) tomatoes on the left with the untreated or control tomato on the right, 57 days into the experiment and untreated o

FIG. 7 is a cross-sectional elevation showing a first embodiment of a storage container for holding produce that utilizes the invention

FIG. 8 is a cross-sectional elevation showing a second embodiment of a storage container for holding produce that utilizes the invention

FIG. 9 is a cross-sectional elevation showing a third embodiment of a storage container for holding produce that utilizes the invention.

FIG. 10 is a cross-sectional elevation showing a fourth embodiment of a storage container for holding produce that utilizes the invention.

### DETAILED DESCRIPTION

Referring to FIGS. 1 through 10, wherein like reference numerals refer to like components in the various views, there is illustrated therein a new and improved methods and device to prevent food spoilage, generally denominated 100 herein.

In accordance with the present invention, it has been discovered that exposing foods, and in particular fresh produce to Tachyonized materials improve the shelf life, greatly delaying dehydration and rot.

Materials are referred to as “Tachyonized” when they have undergone a proprietary treatment. Currently, such materials are available from Advanced Tachyon Technologies of Santa Rosa, Calif. The treatment is believed to enable the harnessing of tachyon energy by the materials, so that when the material is placed near living objects biological effects are observed, in particular healing effects in living organisms over an extended period of time. For example, the original supplier and developer of Tachyonized materials, Advanced Tachyon Technologies, states in its literature and website:

“The use of Tachyonized products normally results in a natural detoxification, increased absorption of available vitamins and minerals, increased energy for physical activities, increased awareness of subtle energies, increased brain function, increased circulation, and exceptional improvements in athletic abilities and muscle recovery. When athletes use these products, they notice a significant decrease in fatigue, allowing for increased performance.”

The benefits of Tachyonized materials for holistic healing are disclosed in, among other sources, in “Tachyon Energy”, by David Wagner and Gabriel Cousens, M.D., North Atlantic Books, Berkeley, Calif. 1999, which is incorporated herein by reference. This reference has a section developed to experiments conducted with plants to demonstrate improved plant health when grown in Tachyonized water.

Further, the theoretical basis for the tachyon particle is described “The Physical of Tachyons”, by Ernst L. Wall, Hadronic Press, Palm Harbour, Fla., 1995, which is incorporated herein by reference.

To test the theory that Tachyonized materials would extend the shelf life of produce, two tomatoes from the same cluster where photographed under long term storage. However, one tomato was placed on the center of a 4-Inch (10 cm) silica square substrate (10 cm) that had not been treated, for the control samples, and while other was placed in the center of a Tachyonized silica square substrate (which will now be referred to as “T”). The Tachyonized substrate was the SD-1 which was obtained from Advanced Tachyon Technologies of Santa Rosa, Calif. The manufacturer's instructions for use were followed in that as the Tachyonized Silica Disks are indicated as having a one directional field effect, the disk was oriented to that the tomato was disposed on the side labeled “Energy flows out this side”. This Tachyonized substrate was marked around the edge with blue tape for identification purposes. Each of the substrates were then spaced about 20 cm apart so that the control and “T” tomatoes had an initial spacing of about 30 cm. The samples were aged indoors in an office environment.

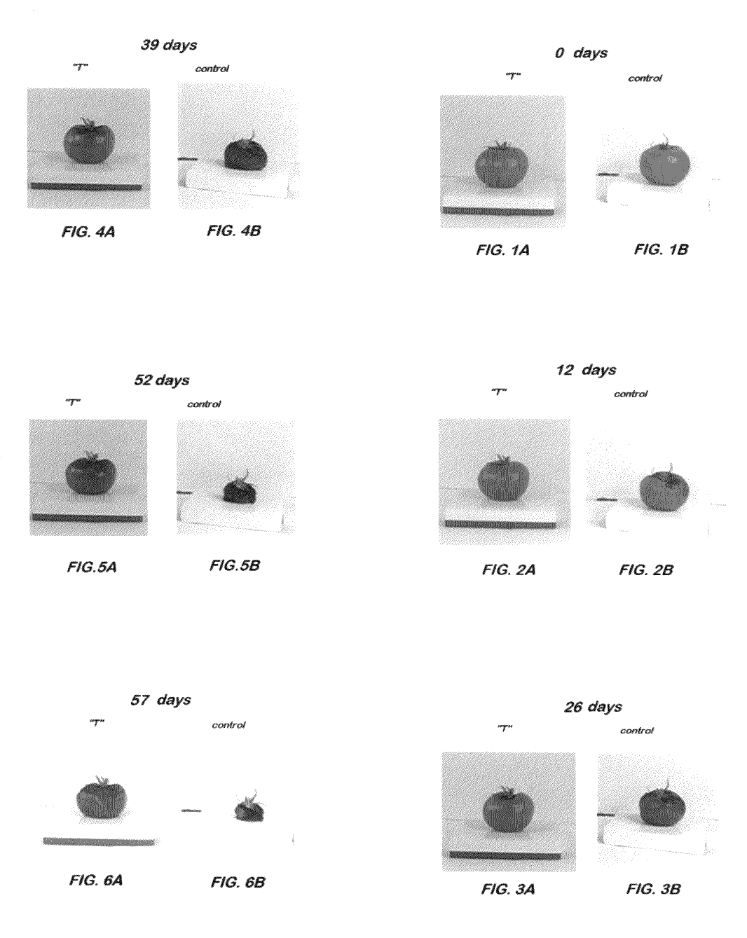

As will be evident from the comparative experimental results shown in FIG. 1-6, it has been discovered that placing produce in proximity to Tachyonized materials delays spoilage and aging, and thus increases shelf life. The series of photographs were taken over a period of 52 days using time lapsed photograph techniques. The control sample is on the right (and is denoted B) while the test sample “T” that was placed on a Tachyonized substrate is on the left (and denoted A). FIG. 1 compares the control and “T” sample the beginning of the experiment, whereas FIG. 2 is after 12 day. FIG. 3 is after 26, FIG. 4 is after 39 days and FIG. 5 is after 52 days and FIG. 6 is after 57 days.

It should be apparent from FIG. 2 that after 12 days the stem side, which faces up, of the control tomato shows shriveling and black rot. However, it is only after 26 days that the “T” sample shows the first signs of rot at the stem, although less pronounced than the control sample at 12 days so that a larger portion still appears edible. In FIG. 3, at 26 days, the control sample on the right has shrunk by about ⅓ in volume and has an overall darker color showing under lying rot, although it is still more pronounced at the stem end.

In FIG. 4, after 39 days the control sample on the right has shrunken to about ½ its original volume, and has shriveled and slumped considerably in that it no longer is strong enough to support its own weight, as the bottom has oozed to conform with the flat substrate. However, while the “T” sample after 39 days has more pronounced rot at the stem, the overall color is still good. The overall condition of the “T” sample still appears better than the control sample after 12 days.

IN FIG. 5, after 52 days the control sample on the right has shriveled to about ⅓ its original size and is clearly totally rotted. However, the “T” sample after 52 days has the rot localized to only the stem side, and has a comparable to slightly better appearance than the control sample at 26 days.

In FIG. 6A, after 57 days the “T” sample has continued to rot and shrivel, however its appearance is comparable to the control sample after between about 26 to 39 days. The control sample on the right in FIG. 6B has continued to shrink and ooze onto the substrate as compared with 52 days (FIG. 5B)

Thus, one embodiment of the invention is the storage of food and fresh produce in close proximity the Tachyonized materials. It is believed that the benefits demonstrated by the Tachyonized silica can be obtained with other commercially available Tachyonized materials, and can be deployed with other types of fresh produce, as well as other foodstuffs.

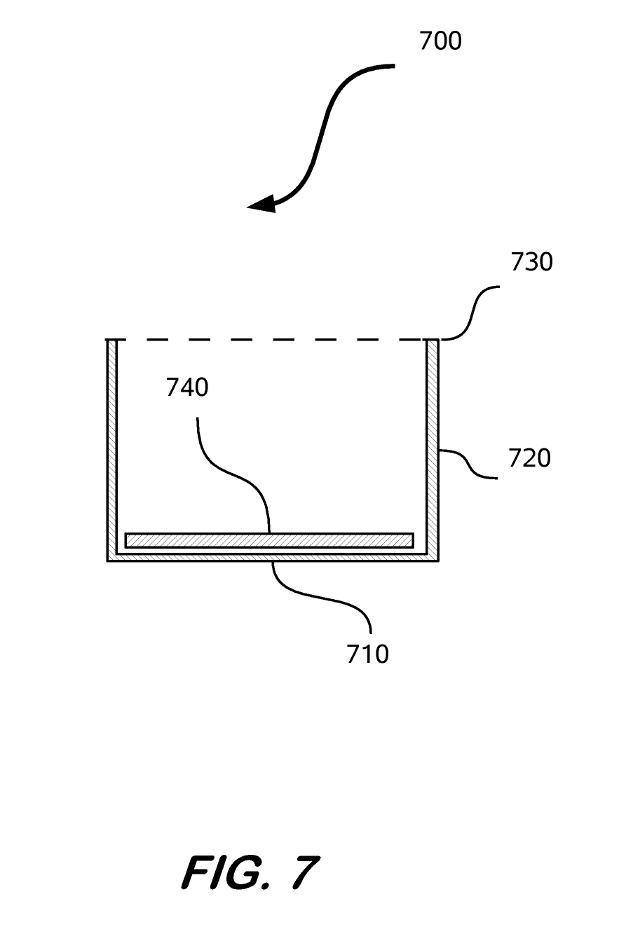

In another embodiment, shown in FIG. 7 there is a container 700 for storing fruit having a bottom 710, and substantially upright side walls 720 extending upward there from to terminate at a rim 730. A Tachyonized disk 740 substantially covers the inside of the bottom so that the benefits of the Tachyonized material expose accrue to all the produce stored in the container.

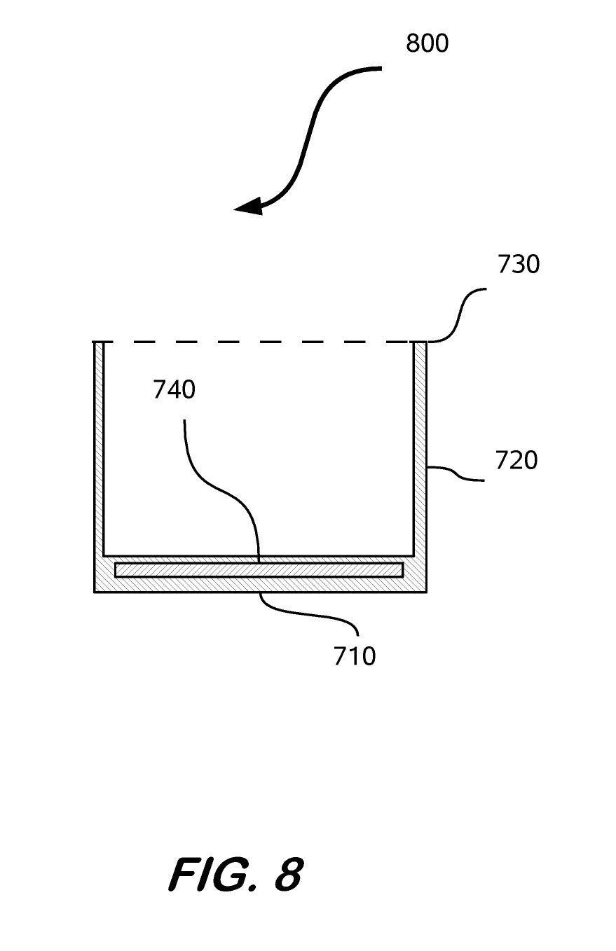

FIG. 8-10 illustrate alternative embodiments of container configured with a Tachyonized disc to improve the shelf life of the produce contained with. In FIG. 8 there is another container, 800 that is comparable to that shown in FIG. 7, however, the Tachyonized disk 740 is embedded in the bottom.

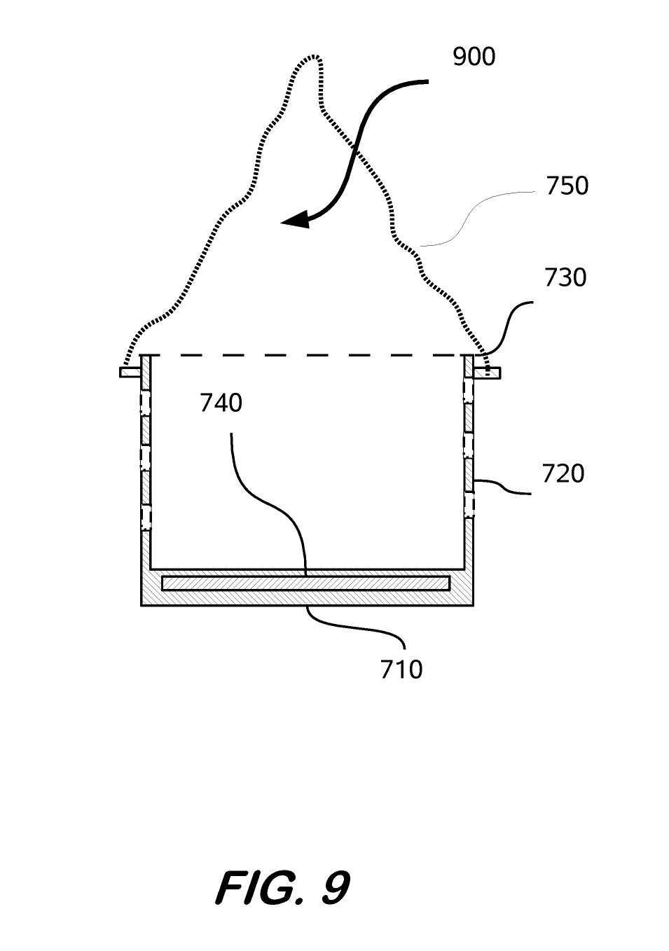

In FIG. 9, another container 900 comparable to that shown in FIGS. 7 and 8, is shown, however at least the sides are perforated and the container can be hung on chains or cable 750.

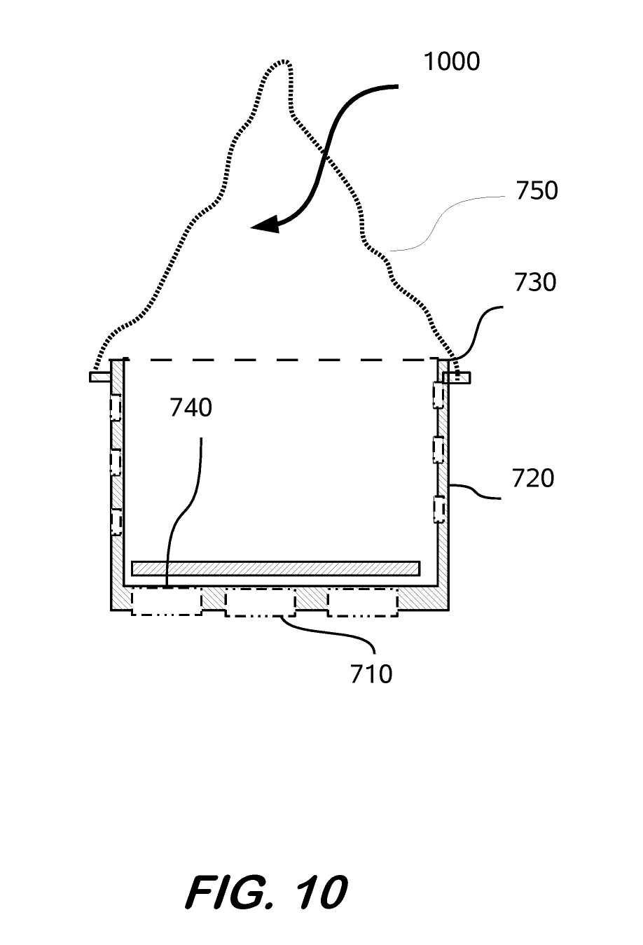

FIG. 10 illustrates yet another embodiment of a container 1000 that is perforated on the bottom and sides and has a Tachyonized disk 740 substantially covering the inside of the bottom.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. A process for extending the shelf life of perishable produce, the process comprising the steps of:
a) providing a tachyonized material,
b) providing produce to be preserved,
c) placing the produce in close proximity to the tachyonized material.

2. A process for extending the shelf life of perishable produce according to claim 1 wherein the produce to be preserved is placed in a container and the tachyonized material is at the bottom of the container.

3. A process for extending the shelf life of perishable produce according to claim 1 wherein the tachyonized material is silica.

4. A device for storing produce, the device comprising:
a) a container having a bottom portion and upward extending sides connected to the periphery of the bottom portion which terminate at the opposite end at a rim to provide a cavity for retaining material,
b) a tachyonized material disposed at the bottom of said container.

5. A device for storing produce according to claim 3 wherein the tachyonized material is embedded in the bottom of the container.

6. A device for storing produce according to claim 3 wherein the container sides are perforated.

7. A device for storing produce according to claim 3 wherein the container bottom and sides are perforated.

8. A device for storing produce according to claim 3 wherein the container further comprises at least one cord secured to the sides thereof for suspending the container above the ground.
